(19) United States
(12) Patent Application Publication
(10) Pub. No.: US 2009/0100006 A1
(43) Pub. Date: Apr. 16, 2009

(54) INDEX CREATING METHOD BY CREATING/INTEGRATING NODE

(76) Inventors: Wataru KAWAI, Yokohama (JP); Taiga Fukushima, Fujisawa (JP); Yasuhiro Tahara, Hiratsuka (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/059,272

(22) Filed: Mar. 31, 2008

(30) Foreign Application Priority Data
Oct. 11, 2007 (JP) 2007-265697

(51) Int. Cl. G06F 17/30

(52) U.S. Cl. 707/2; 707/E17.009

(57) ABSTRACT

There is provided a method of creating an index, which is executed in a document retrieval apparatus. The index includes index information and a trie, the index information includes an index item formed of a character string, the trie is formed of a plurality of nodes each including a part of the character string of the index item, and the index information and each of the plurality of nodes of the trie are associated with each other. The method comprises the steps of: dividing the index information by a unit of an index information block when a first node of the trie is associated with a plurality of the index information blocks, and a search time required for searching all the index information associated with the first node of the trie exceeds a predetermined first threshold; and associating the divided index information with the second node.

### CLAIM OF PRIORITY

The present application claims priority from Japanese patent applications JP 2007-265697 filed on Oct. 11, 2007, the content of which are hereby incorporated by reference into this application.

### BACKGROUND OF THE INVENTION

This invention relates to a technology for constructing an index used in a document retrieval system.

There is known a method of using an index to perform a fast retrieval of a document that contains a specified search character string from a large-scale document database. Recorded in the index are index items indicating a plurality of keywords contained in documents to be searched, document identification information for identifying a document that contains the index item, and index information containing location information of the index item in the document in question.

In such an index construction method as described above, index items in documents are managed by means of a tree structure such as a trie. The index information is associated with a node (leal) of the tree structure. As disclosed in JP 08-194718 A, the trie has a tree structure in which a partial character string (symbol string) common in keywords (hereinafter, referred to as “key”), which are character strings to be searched for, that is, a set of keywords (hereinafter, referred to as “key set”), is aligned along shared nodes (hereinafter, referred to as “node” or “trie node”) in a hierarchical manner. A computer parses a search character string into keys, thereby searching the trie with use of the key. Then, when a node that matches the key is found, the computer obtains pointer information set for the node in question, and reads out the index information corresponding to the key.

Further, in an embedded device, all data regarding the trie is stored in a primary storage device (memory) for the purpose of improving the search performance. Therefore, there is provided a method of reducing the size of the trie stored in the memory, by which a plurality of nodes of the trie are integrated into one node (hereinafter, referred to as “merge node”). For example, when the trie has a node “A”, a node “B”, and a node “C”, those three nodes are integrated into one merge node “A-C”.

Next, description will be made of the index information. The index information includes a character string, a document number, and an appearance location. JP 2001-312517 A discloses a technology of compressing the index information by consolidating pieces of the index information that have an identical character string and obtaining the difference between those pieces. In this case, only the pieces of the index information that have the identical character string are compressed, and the resultant index information obtained by compressing the plurality of pieces of the index information that have the identical character string is regarded as one index information group (hereinafter, referred to as “index information block”).

### SUMMARY OF THE INVENTION

In a case where a computer manages the index information with a trie that includes a merge node, which manages a plurality of index information blocks altogether, there is a possibility that bloating or sparsity of the index information blocks occurs locally when a plurality of operations including updating of the index information are executed.

The bloating of index information blocks is a phenomenon in which the amount of information in a plurality of index information blocks managed by a particular merge node increases enormously due to the concentration of addition of index information with respect to the plurality of index information blocks managed by the merge node in question. When the index information block after the bloated index information blocks is to be searched, it takes much longer to extract desired index information, resulting in deterioration of the search performance.

The sparsity of index information blocks is a phenomenon in which the amounts of the index information of individual index information blocks decrease enormously due to the concentration of deletion of index information with respect to the index information blocks managed by a couple of nodes or merge nodes. In this case, the amounts of index information managed by the nodes or the merge nodes that have been subjected to the deletion become extremely small, resulting in deterioration of the memory use efficiency for the trie.

This invention has been made in view of the above-mentioned problems, and it is therefore an object of this invention to maintain high memory use efficiency for a trie while maintaining a state in which search of index information can be started within a permissible search time even though addition and deletion of the index information are repeatedly executed.

A representative aspect of this invention is as follows. That is, there is provided a method of creating an index, which is executed in a document retrieval apparatus for retrieving a document. The index includes index information and a trie, the index information includes an index item formed of a character string extracted by dividing the document by a predetermined number of the character, the trie is formed of a plurality of nodes each including a part of the character string of the index item, the document retrieval apparatus has a processor and a storage unit, the trie is created in the storage unit, the index information is managed for each index information block constituted of a plurality of pieces of the index information whose index items are identical, and the index information and each of the plurality of nodes of the trie are associated with each other by associating at least one index information block with the each of the plurality of nodes of the trie. The method executed by the processor comprises the steps of: dividing the index information by a unit of an index information block when a first node of the trie is associated with a plurality of the index information blocks, and a search time required for searching all the index information associated with the first node of the trie exceeds a predetermined first threshold; creating a new second node that is to be connected directly below a parent node of the first node of the trie that is associated with the plurality of the index information blocks containing the index information to be searched; and associating the divided index information with the second node.

According to an embodiment of this invention, even though the addition of the index information is repeatedly executed due to a long-term operation, it is possible to maintain a state in which the search of the index information can be started within a predetermined permissible search time.

### BRIEF DESCRIPTION OF THE DRAWINGS

The present invention can be appreciated by the description which follows in conjunction with the following figures, wherein:

FIG. 1 is a block diagram showing a configuration of a document registration/retrieval system in accordance with a first embodiment of this invention;

FIG. 2 is an explanatory diagram showing a state of an index before dividing an index information dividing in accordance with the first embodiment of this invention;

FIG. 3 is an explanatory diagram showing a graph indicating a search time necessary for searching the index information in the index before dividing the index information in accordance with the first embodiment of this invention;

FIG. 4 is an explanatory diagram showing a state of an index after dividing the index information in accordance with the first embodiment of this invention;

FIG. 5 is an explanatory diagram showing a graph indicating search times necessary for searching the index information in the index after dividing the index information in accordance with the first embodiment of this invention;

FIG. 6 is a program analysis diagram (PAD) showing the steps of a processing executed by an index information dividing module in accordance with the first embodiment of this invention;

FIG. 7 is a PAD showing the steps of a processing executed by an index information change module in accordance with the first embodiment of this invention;

FIG.8 is a PAD showing the steps of a processing executed by a trie node dividing module in accordance with the first embodiment of this invention;

FIG. 9 is a diagram showing a configuration of a document registration/retrieval system in accordance with a second embodiment of this invention;

FIG. 10 is an explanatory diagram showing a state of an index before the index information integration in accordance with the second embodiment of this invention;

FIG. 11A and FIG. 11B are graphs exemplifying search times necessary for searching the index information before the index information integration in accordance with the second embodiment of this invention;

FIG. 12A and FIG. 12B are diagrams showing indexes after the index information integration in accordance with the second embodiment of this invention;

FIG. 13A and FIG. 13B are graphs exemplifying search times necessary for searching the index information after the index information integration in accordance with the second embodiment of this invention;

FIG. 14 is a PAD showing the steps of a processing executed by an index information integration module in accordance with the second embodiment of this invention; and

FIG. 15 is a PAD showing the steps of a processing executed by a trie node integration module in accordance with the second embodiment of this invention.

### DETAILED DESCRIPTION OF THE PREFERRED EMBODIMENTS

Hereinafter, description will be made of embodiments of this invention with reference to the drawings.

### First Embodiment

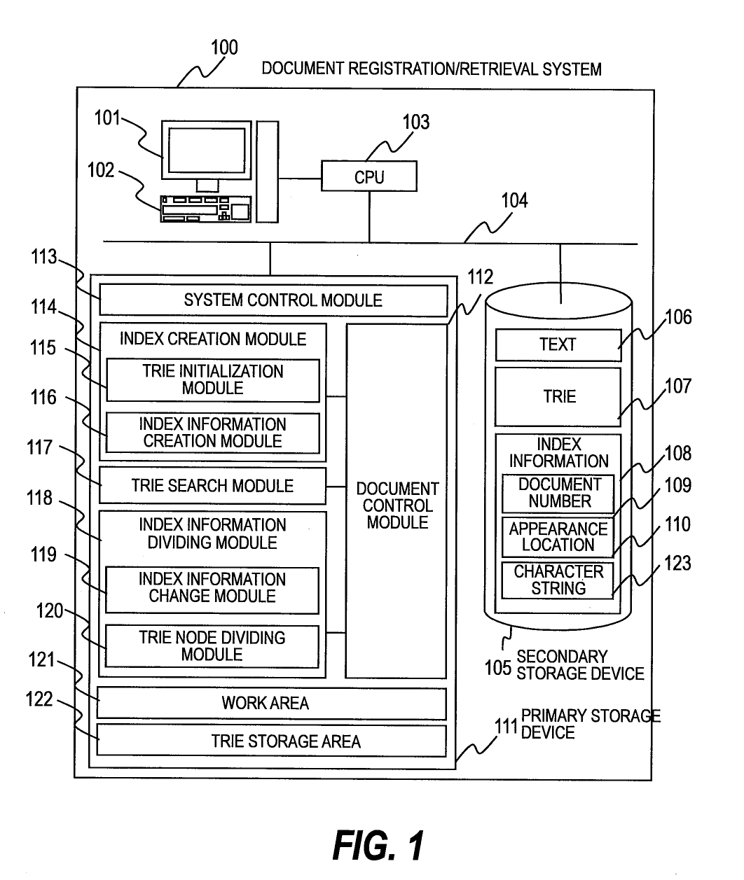

FIG. 1 is a block diagram showing a configuration of a document registration/retrieval system 100 according to a first embodiment of this invention.

In the first embodiment of this invention, described is a method for keeping a search start time within a permissible search time by dividing bloated index information.

According to the first embodiment of this invention, the document registration/retrieval system (trie generation device and document retrieval device) 100 includes an output device 101, an input device 102, a central processing unit (CPU) 103, a primary storage device 111, and a secondary storage device 105, which are all coupled with one another through a bus 104. In the document registration/retrieval system according to the first embodiment of this invention, a single computer is equipped with all functions, but the document registration/retrieval system may be configured to include a plurality of computers so that, for example, documents to be retrieved may be stored in another computer.

The output device 101 displays a result of search executed by the CPU 103 and the like. The output device 101 is, for example, a display. The input device 102 is used to register a document and to input a search command and a search character string. The input device 102 is, for example, a keyboard.

The primary storage device 111 stores constituent modules for implementing an index registration function and an index search function, and temporarily stores data and the like that are input and output in each processing. The CPU 103 executes the index registration processing and the search processing for a search character string by executing the constituent modules stored in the primary storage device 111. Stored in the secondary storage device 105 are the above-mentioned data and constituent modules.

Further, the secondary storage device 105 is provided with a disk cache (not shown). The disk cache enables fast readout of data by duplicating part of data stored in a slow-access storage device such as an HDD. The disk cache is formed of a semiconductor memory such as a random access memory (RAM) provided to the secondary storage device 105. The primary storage device 111 is also formed of a RAM or the like. The secondary storage device 105 is formed of a hard disk drive (HDD), a flash memory, or the like.

Stored in the secondary storage device 105 are a system control module 113 for controlling the document registration/retrieval system 100 in its entirety, a document control module 112 and an index creation module 114 for a registration processing, and a trie search module 117 and an index information dividing module 118 for search and update processings. The system control module 113, the document control module 112, the index creation module 114, the trie search module 117, and the index information dividing module 118 are all programs. Those constituent modules are read out into the primary storage device 111, and then executed by the CPU 103. FIG. 1 shows a state in which the constituent modules are read out into the primary storage device 111. Further, the primary storage device 111 is allocated a work area 121 and a trie storage area 122 for temporarily storing the above-mentioned data.

Next, outlines will be given of processings executed by the respective constituent modules.

The system control module 113 presents information to a user through the output device 101, and receives an input from the user through the input device 102. Further, the system control module 113 controls the execution of other constituent modules.

The document control module 112 controls the index creation module 114, the trie search module 117, and the index information dividing module 118.

The index creation module 114 includes a trie initialization module 115 and an index information creation module 116. The trie initialization module 115 initializes the trie. The index information creation module 116 creates (generates) index information. Specifically, the index information creation module 116 divides a search target document into character strings by an arbitrary gram count (character count), and creates (generates) a plurality of index information items including a document number 109, an appearance location 110, and a character string 123. In addition, the index information creation module 116 collects pieces of index information having the same character string, and aligns those pieces in ascending order according to the document numbers. In a case where those pieces have the same document number, those pieces are aligned according to the appearance locations. Lastly, the index information creation module 116 deletes overlapping information from the aligned pieces of index information, and generates an index information block.

The trie search module 117 searches the trie and obtains desired index information.

The index information dividing module 118 includes an index information change module 119 and a trie node dividing module 120. The index information change module 119 executes the update or the dividing of an index information block that has been searched by the trie search module 117. The trie node dividing module 120 divides a trie node formed of a plurality of nodes, and associates a newly generated trie node with the divided index information block.

The secondary storage device 105 stores a text 106, a trie 107, and a plurality of pieces of index information 108. The text 106 is document data. The index information 108 is associated with the text 106, and includes the document number 109, the appearance location 110, and the character string 123. The trie 107 stores information regarding the structure of the trie. Hereinabove, the description of the configuration of the first embodiment of this invention has been made. Hereinafter, an index information dividing processing according to the first embodiment of this invention will be described.

(Index Information Dividing)

The index information dividing processing is executed, in the course of the index search processing or the update processing with use of a keyword input by a user, by the CPU 103 processing the document control module 112 via the system control module 113.

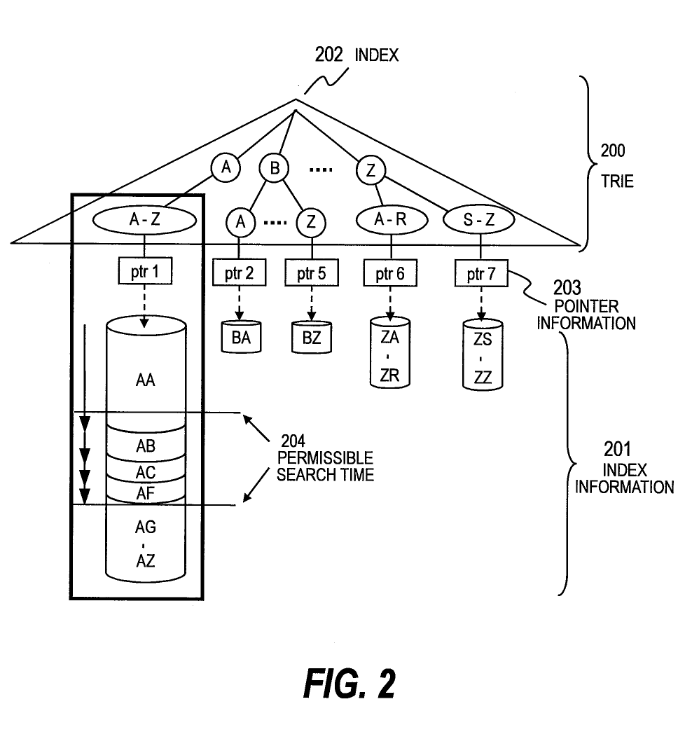

FIG. 2 shows a state of an index 202 before the index information dividing according to the first embodiment of this invention, in which a part of the index information is bloated.

An index 202 includes a trie 200, index information 201, and pointer information 203. As an example, a case in which a character string “AG” is updated in the index 202 will be described. The CPU 103 executes the trie search module 117, and traces the trie 200 sequentially from a node “A” at the uni-gram level to a merge node “A-Z” at the bi-gram level coupled with the node “A”, thereby storing the index information indicated by pointer information 203 (ptr 1) in the work area 121.

Further, the CPU 103 executes the index information dividing module 118, and starts searching from the head of the index information stored in the work area 121 until “AG” appears. In the course of this processing, as shown in FIG. 1, a permissible search time 204 elapses twice; once during the search of an index information block “AA” and then once during the search of an index information block “AF”.

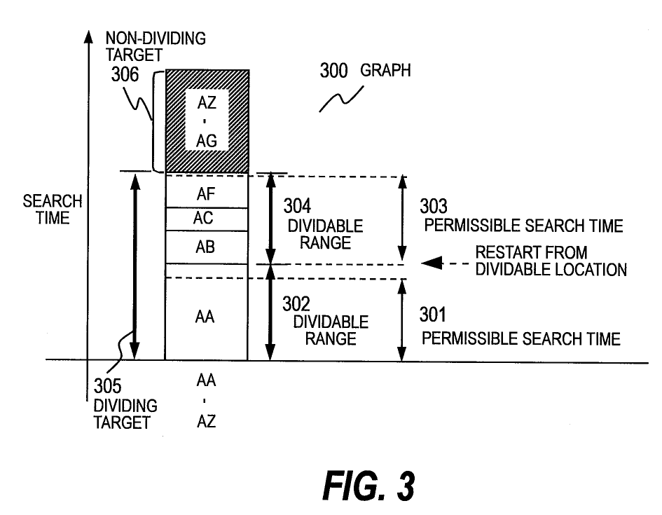

FIG. 3 shows a graph 300 indicating a search time necessary for searching the index information in the index 202 before the index information dividing according to the first embodiment of this invention.

According to the first embodiment of this invention, the index information is divided on an index information block basis, so a dividable range is constituted of one or more index information blocks. Also, one or more index information blocks from the head of the index information through immediately before the index information block “AG” constitutes a dividing target 305.

According to the first embodiment of this invention, a permissible search time 301 first elapses during the search of the index information block “AA” before the character string “AG” is retrieved. At this stage, the index information dividing module 118 judges that the dividing of the index information is necessary for the index information block “AA”. Because the index information block “AA” equals to a dividable range 302, the subsequent measurement of a permissible search time 303 starts from an index information block “AB”.

In the course of the continued search for the character string “AG”, the permissible search time 303 elapses again during the search of the index information block “AF”. At this stage, the index information dividing module 118 judges that the dividing of the index information is necessary for the index information block “AF”. A dividable range 304 is from the index information block “AB” to the index information block “AF”, and the subsequent measurement of the permissible search time starts from the index information block “AG”.

Because the index information block “AG” is the index information block that contains search target index information, the CPU 103 executes the index information dividing module 118, and searches the index information block “AG”. It should be noted that the index information blocks after the index information block “AG” is regarded as a non-dividing target 306. In a case where an index information block “AX” is searched for on another occasion, for example, if the permissible search time elapses, the CPU 103 executes the index information dividing module 118 to divide the index information.

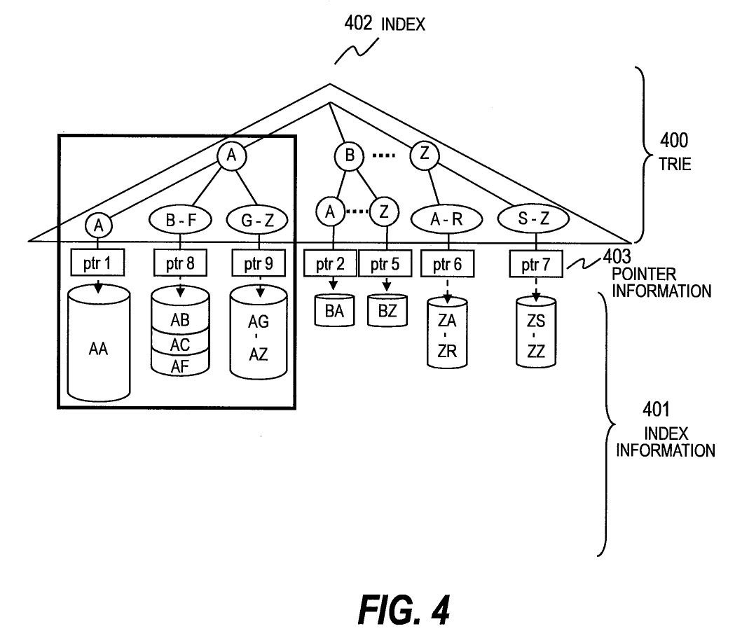

FIG. 4 shows a state of an index 402 after the index information dividing according to the first embodiment of this invention.

The index 402 includes a trie 400, index information 401, and pointer information 403. As described above, the index information, which is indicated by the pointer information 203 (ptr 1) in the index 202 shown in FIG. 2, is divided into three pieces of index information. Specifically, in the trie 200, the merge node “A-Z” is coupled with the node “A”. On the other hand, in the trie 400, where the index information is divided, three nodes, that is, a node “A”, a merge node “B-F”, and a merge node “G-Z” are coupled with the node “A”. Subsequently, a ptr 8 and a ptr 9 are newly added to the pointer information 403. Stored in the ptr 8 is pointer information indicating the index information from the index information block “AB” to the index information block “AF”, and stored in the ptr 9 is pointer information indicating the index information from the index information block “AG” to the index information block “AZ”. In addition, the ptr 1 in the pointer information 403 is changed to indicate only the index information block In this way, it is made possible to start searching “AG” within the permissible search time by dividing, with the permissible search time being a threshold, the merge node “A-Z” into three nodes including merge nodes, that is, the node “A”, the merge node “A-F”, and the merge node “G-Z”. Also, with regard to the index information whose index items are indicated with the character strings from “AB” to “AF”, the search can be started within the permissible search time.

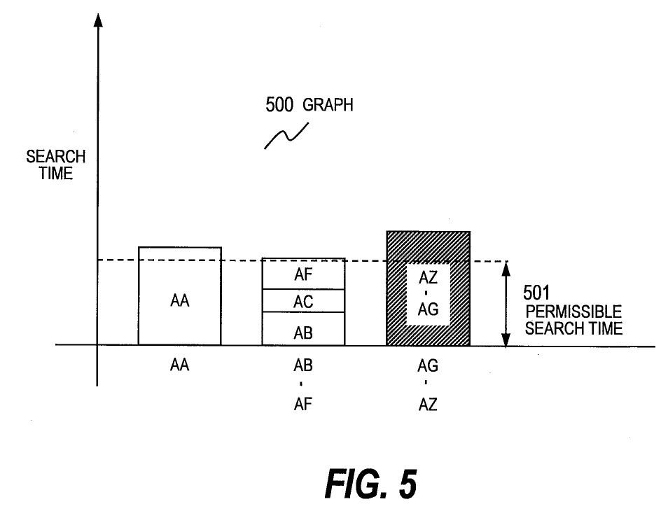

FIG. 5 shows a graph 500 indicating search times necessary for searching the index information in the index 402 after the index information dividing according to the first embodiment of this invention.

The graph 500 shows a search time for each of the node “A”, the merge node “B-F”, and the merge node “G-Z”, which are immediately below the node “A” at the uni-gram level. With regard to the dividing target 305 as shown in FIG. 3, which is from the index information block “AA” to the index information block “AF”, as a result of the dividing of the index information on the basis of the permissible search time, the search can be started within a permissible search time 501 for all the index information blocks of the dividing target 305.

As described above, the index information from the index information block “AG” to the index information block “AZ” is the non-dividing target in the case where the character string “AG” is a search target. In such a case, for example, when a search for the character string “AZ” is executed, the index information from the index information block “AG” to the index information block “AZ” becomes the index information dividing target. Moreover, if the index information dividing module 118 judges that the dividing of the index information is necessary, the index information from the index information block “AG” to the index information block “AZ” is divided.

(Index Information Dividing Module)

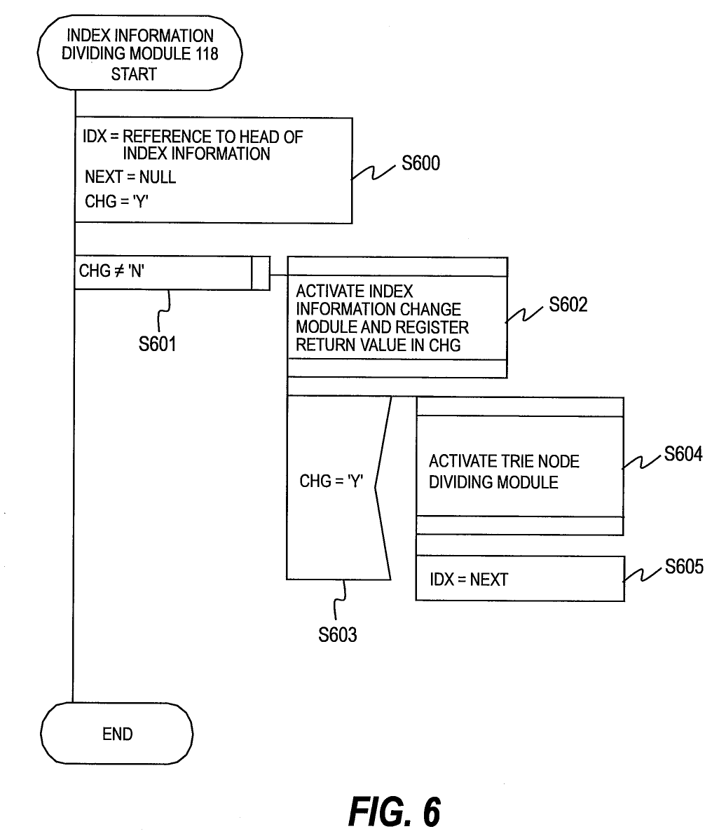

FIG. 6 is a program analysis diagram (PAD) showing the steps of the processing executed by the index information dividing module 118 according to the first embodiment of this invention.

First, the CPU 103 executes the index information dividing module 118, and obtains the index information indicated by the pointer information that belongs to a node retrieved by the trie search module 117. Next, the CPU 103 stores the obtained index information in the work area 121, and registers the address of the store destination in a variable IDX. Further, the CPU 103 registers a value of NULL (invalid value) in a variable NEXT that indicates the address of the index information to be searched or updated next. Further, the CPU 103 registers ‘Y’ (dividing necessary) in a variable CHG that is for judging whether or not the dividing of the index information is necessary (S600).

Next, the CPU 103 executes the index information change module 119, and searches or updates the index information. As a result of the execution of the index information change module 119, when it is necessary to divide the index information, ‘Y’ is registered in the variable CHG, and the address of the index information to be searched and updated after the dividing, which is stored in the work area 121, is stored in the variable NEXT. When there is no need to divide the index information, meaning that the search or the update of the index information has already been completed, ‘N’ (dividing unnecessary) is registered in the variable CHG (S602).

When the result of execution of the index information change module 119 indicates ‘Y’, that is, when it is judged that the dividing of the index information is necessary (S603), the CPU 103 executes the trie node dividing module 120. Upon the execution of the trie node dividing module 120, the node corresponding to the index information that is currently being searched is divided into two nodes; a node for managing the index information blocks up to immediately before the index information block that includes the index information indicated by the variable NEXT and a node for managing the index information block that includes the index information indicated by the variable NEXT. Subsequently, a pointer indicating the index information indicated by the variable NEXT is registered for the node managing the index information block that includes the index information indicated by the variable NEXT (S604).

The CPU 103 registers the value of the variable NEXT as the value of the variable IDX, and executes the index information change module 119 again (S605). A series of those steps of the processing are repeatedly executed until the index information change module 119 judges that the dividing of a node is unnecessary (S601).

(Index Information Change Module)

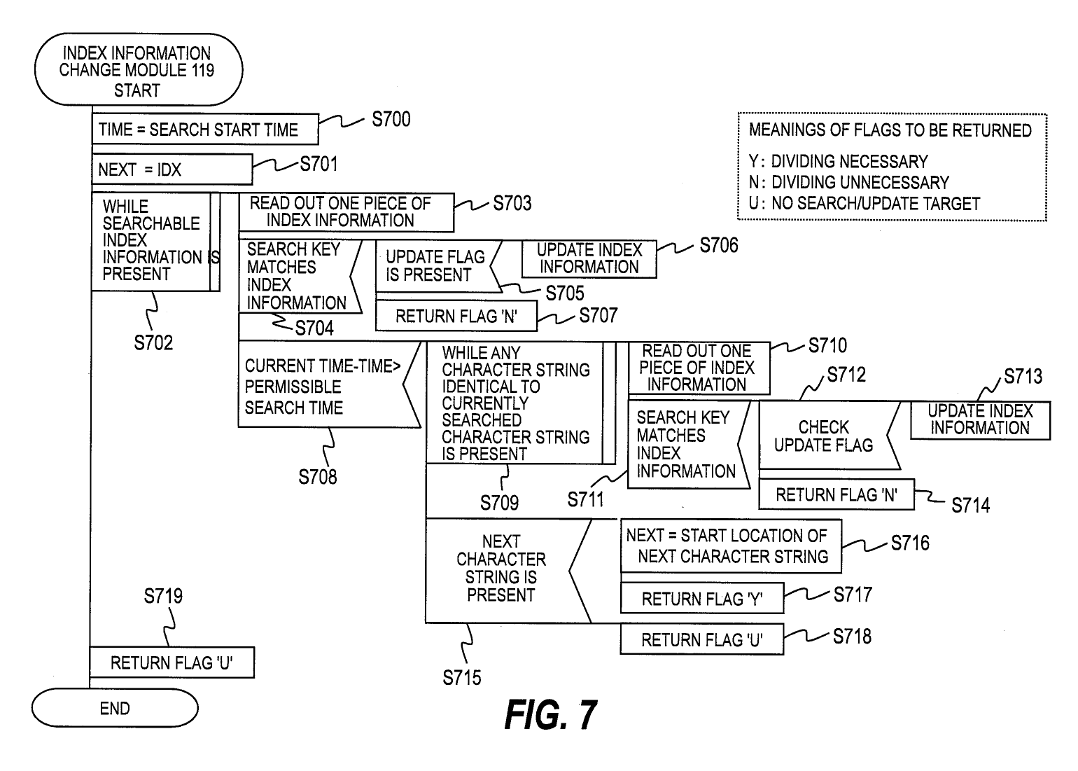

FIG. 7 is a PAD showing the steps of the processing executed by the index information change module 119 according to the first embodiment of this invention.

First, the CPU 103 stores a current time in a variable TIME as a search start time (S700). Further, the CPU 103 stores in the variable NEXT the address of the search target index information stored in the work area 121 (S701).

When the work area 121 contains at least one searchable piece of the index information indicated by the variable NEXT (S702), the CPU 103 reads out one piece of the index information (S703). When the work area 121 does not contain any searchable index information, the CPU 103 sends a no-search/update target flag (‘U’) for indicating that the index information has no search target to an invoker (S719).

When the index item of the read-out index information matches the search key (S704), the CPU 103 further judges whether or not the read-out index information is the update target (S705). Then, when the read-out index information is the update target, the CPU 103 updates the index information in question or the index information located immediately before and after the index information in question (S706). It should be noted that an update flag for judging whether or not the index information is to be updated is set by the processing of the invoker executing the index information dividing module 118. Once the index information of the search or update target is obtained, because there is no need to further search or update the index information, this processing is ended, and a dividing unnecessary flag (‘N’) is sent to the invoker (S707).

On the other hand, when the search time exceeds the permissible search time with no matching index item found in the read-out index information (S708), the CPU 103, until the traversal of the index information block that is currently searched is completed (S709), reads out the index information one by one in order (S710). The CPU 103 then checks whether or not the index item of the read-out index information matches the search key (S711), and, when the read-out index information is the update target (S712), updates the index information (S713). When the index information of the search or update target is read out, the location at which this index information has been read out is set as the end point of the search or update processing, and the dividing unnecessary flag (‘N’) is sent to the invoker (S714).

When the search time exceeds the permissible search time and the traversal of the index information block that is currently searched is completed, the CPU 103 judges whether or not there is another index information block to be searched next (S715). When there is another index information block to be searched next, the CPU 103 stores in the variable NEXT the address of the work area in which this next index information block is stored (S716), and sends the dividing necessary flag (‘Y’) to the invoker (S717). When there is no index information block to be searched next, the CPU 103 sends the no-search/update target flag (‘U’) for indicating that there is no search target in the index information to the invoker (S718).

(Trie Node Dividing Module)

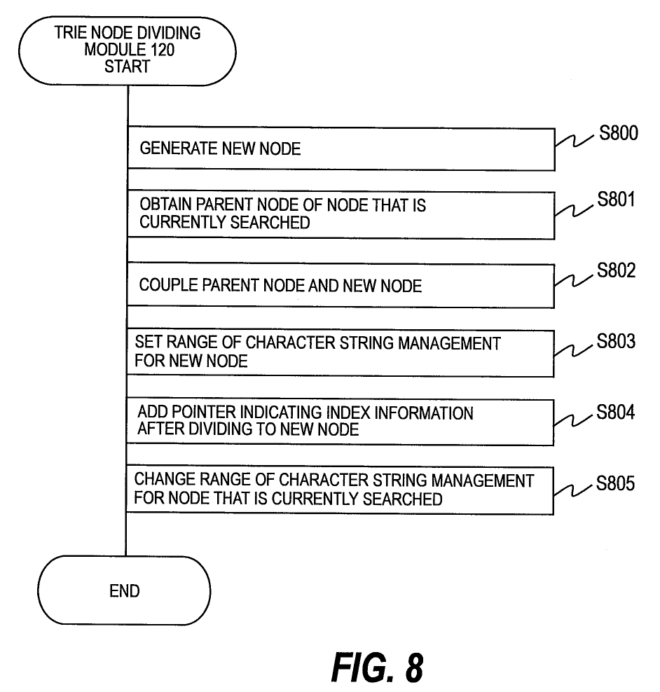

FIG. 8 is a PAD showing the steps of the processing executed by the trie node dividing module 120 according to the first embodiment of this invention.

First, the CPU 103 creates (generates) a new node for managing the divided index information in the trie storage area 122 (S800). Subsequently, the CPU 103 obtains a parent node of the node that is currently searched (S801), and couples the newly created node to the obtained parent node (S802).

The CPU 103 sets a range of character string management for the newly generated node as being from the character string of the index information block of the dividing target to the last character string managed by the node before the dividing (S803). Further, the CPU 103 registers a pointer indicating the divided index information in the newly generated node (S804). Then, the CPU 103 sets, for the node that is currently searched, a character string immediately before the character string indicating the index information block of the dividing target as the last character string for the range of the character string management (S805).

According to the first embodiment of this invention, it is possible to prevent deterioration of the search performance due to the bloated index information blocks.

Further, according to the first embodiment of this invention, the index information dividing processing is executed at a time when the update processing or the search processing of the index information is executed. Accordingly, the user can divide the bloated index information without paying particular attention while executing other normal operations. It should be noted that the index information dividing processing may be executed at the user's instruction so that the user can perform the maintenance on the index information in the document registration/retrieval system 100, or may be executed on a regular basis.

### Second Embodiment

In the first embodiment of this invention, the method for improving the search performance by dividing the bloated index information blocks has been described. In a second embodiment of this invention, a processing for the case in which index information blocks become sparse will be described.

As described above, when index information blocks become sparse, the memory use efficiency of the trie declines because the amount of the index information managed by a node or a merge node becomes very small. In the second embodiment of this invention, a method for improving the memory use efficiency of the trie by integrating the sparse index information will be described.

In the second embodiment of this invention, description common to that of the first embodiment of this invention will be omitted as needed.

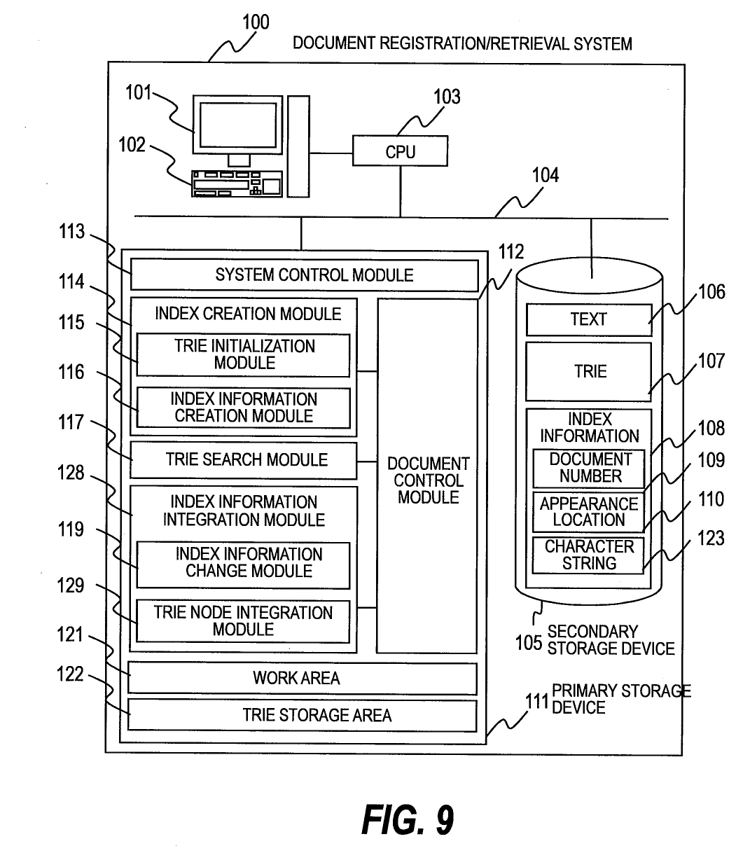

FIG. 9 is a diagram showing a configuration of the document registration/retrieval system 100 according to the second embodiment of this invention.

The document registration/retrieval system according to the second embodiment of this invention is different from that of the first embodiment of this invention in that the index information dividing module 118 is replaced by an index information integration module 128. The rest of the configuration is the same as that of the first embodiment of this invention.

The index information integration module 128 includes the index information change module 119 and a trie node integration module 129. The processing executed by the index information change module 119 is the same as that of the first embodiment of this invention. The trie node integration module 129 integrates a plurality of trie nodes. The processings executed by the index information integration module 128 and the trie node integration module 129 will be described later in detail.

Hereinafter, the index information integration processing according to the second embodiment of this invention will be described.

### (Index Information Integration)

The index information integration processing is executed, in the course of the index search processing or the update processing with use of a keyword input by the user, by the CPU 103 processing the document control module 112 via the system control module 113.

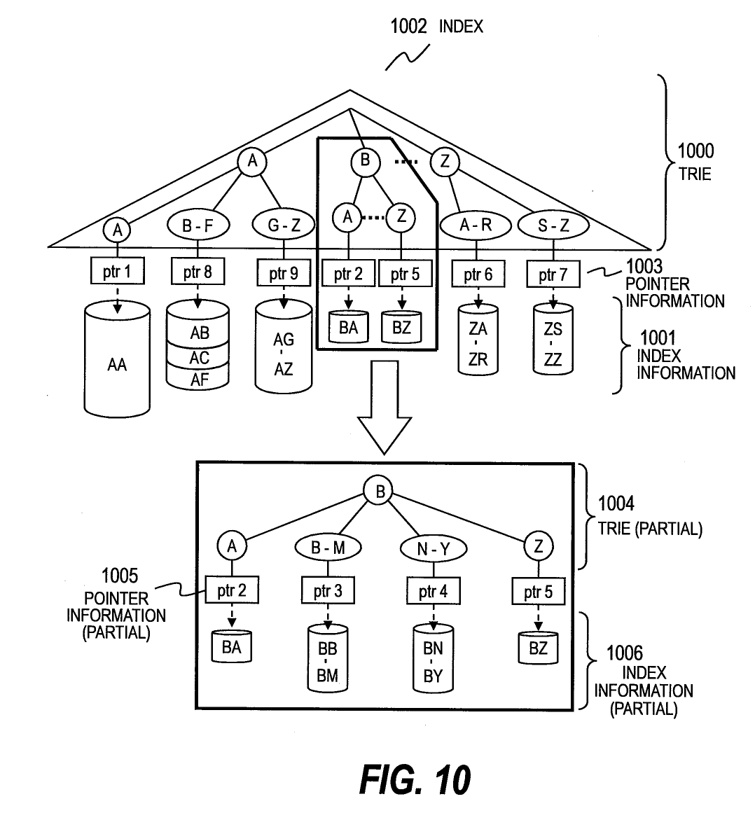

FIG. 10 is a diagram showing a state of an index before the index information integration according to the second embodiment of this invention, in which a part of the index information is sparse.

An index 1002 includes a trie 1000, index information 1001, and pointer information 1003. The upper part of the diagram shows the entire structure of the trie 1002, and the lower part of the diagram is an enlarged view of the part of the index 1002 that is associated with the character string “B”.

When the character string “B” is searched for in the index 1002, the trie search module 117 is executed to search all the index information managed by the nodes or the merge nodes coupled with the node “B” at the uni-gram level in the trie 1000. Coupled below the node “B” at the uni-gram level in the trie 1000 to be searched are a trie 1004, index information 1006, and pointer information 1005. Specifically, the node “B” is coupled with a node “A”, a merge node “B-M”, a merge node “N-Y”, and a node “Z”, which each manage one or more small index information blocks.

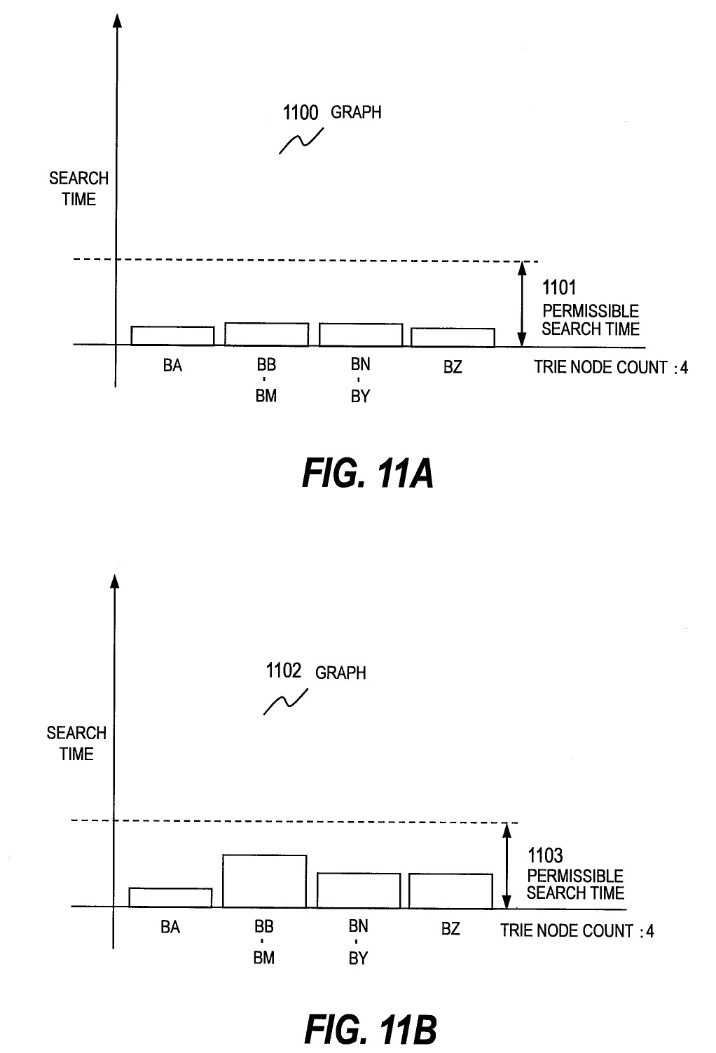

FIG. 11A and FIG. 11B are graphs exemplifying search times necessary for searching the index information before the index information integration according to the second embodiment of this invention.

A graph 1100 and a graph 1102 each show search times necessary for searching the index information associated with the node “A”, the merge node “B-M”, the merge node “N-Y”, and the node “Z”, which are all coupled with the node “B” at the uni-gram level in the trie 1000 shown in FIG. 10.

Referring to the graph 1100 and the graph 1102, though searching any index information block indicated by any node or merge node takes much less than a permissible search time 1101 or a permissible search time 1103, the memory is consumed for four nodes to store the nodes or the merge nodes of the trie 1000.

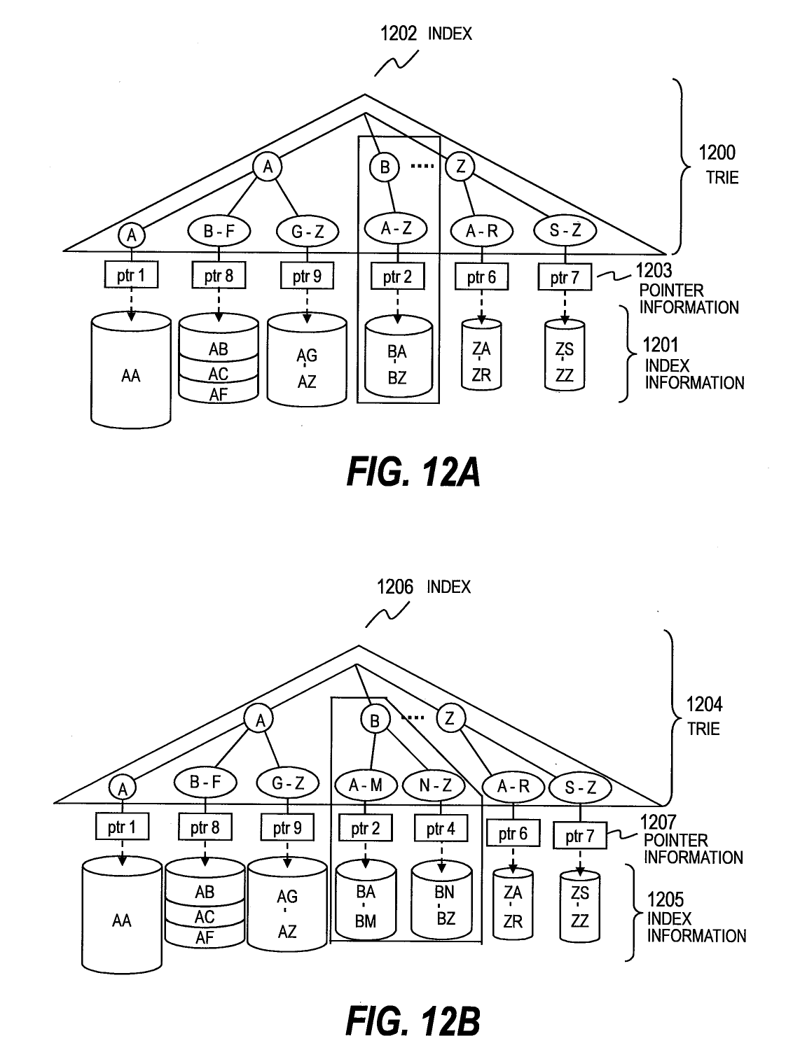

FIG. 12A and FIG. 12B are diagrams showing indexes after the index information integration according to the second embodiment of this invention.

An index 1202 and an index 1206 exemplify indexes after the index information integration processing is executed with respect to the index 1002 shown in FIG. 10.

The index 1202 corresponds to the index information shown in FIG. 11A. The index 1202 includes a trie 1200, index information 1201, and pointer information 1203. The index 1202 is different from the index of FIG. 10 in that the four nodes coupled with the node “B” at the uni-gram level in the trie 1000 shown in FIG. 10, that is, the node “A”, the merge node “B-M”, the merge node “N-Y”, and the node “Z”, are integrated into one merge node “A-Z”. Also, a ptr 3, a ptr 4, and a ptr 5 are deleted from the pointer information 1203, and a ptr 2 manages the pointer information indicating the index information from the index information block “BA” to the index information block “BZ”.

Further, the index 1206 corresponds to the index information indicated in FIG. 11B. The index 1206 includes a trie 1204, index information 1205, and pointer information 1207. In the index 1206, the node “A” and the merge node “B-M”, which are coupled with the node “B” at the uni-gram level in the trie 1000 shown in FIG. 10, are integrated into one merge node “A-M”, and the merge node “N-Y” and the node “Z” are integrated into one merge node “N-Z”. Deleted from the pointer information 1207 are a ptr 3 and a ptr 5. A ptr 2 manages the pointer information indicating the index information from the index information block “BA” to the index information block “BM”, and a ptr 4 manages the pointer information indicating the index information from the index information block “BN” to the index information block “BZ”.

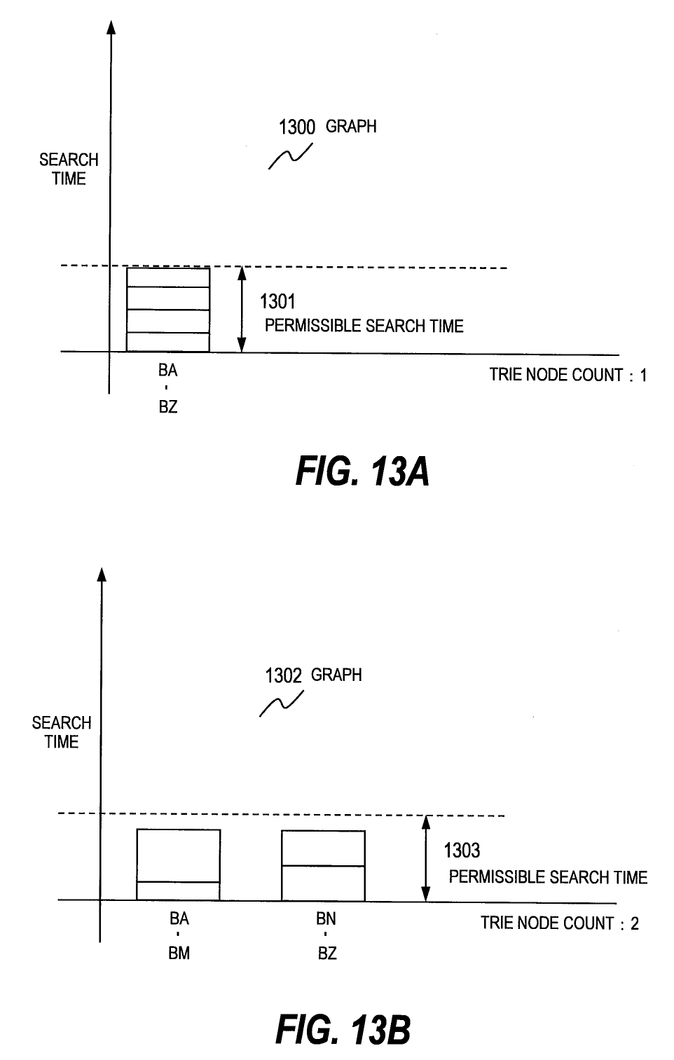

FIG. 13A and FIG. 13B are graphs exemplifying search times necessary for searching the index information after the index information integration according to the second embodiment of this invention.

A graph 1300 shown in FIG. 13A shows a search time in the index 1202 after the index information integration. Referring to the graph 1300, it is understood that when the index information is integrated using a permissible search time 1301 as a reference, the search start time for the integrated index information block falls within the permissible search time 1301.

In addition, a graph 1302 shown in FIG. 13B shows search times in the index 1206 after the index information integration. Referring to the graph 1302, it is understood that when the index information is integrated using a permissible search time 1303 as a reference, the search start times for the respective integrated index information blocks fall within the permissible search time 1303.

By integrating the index information as described above, it is possible to reduce the amount of the memory consumed for generating a node or a merge node, thereby improving the memory use efficiency.

(Index Information Integration Module)

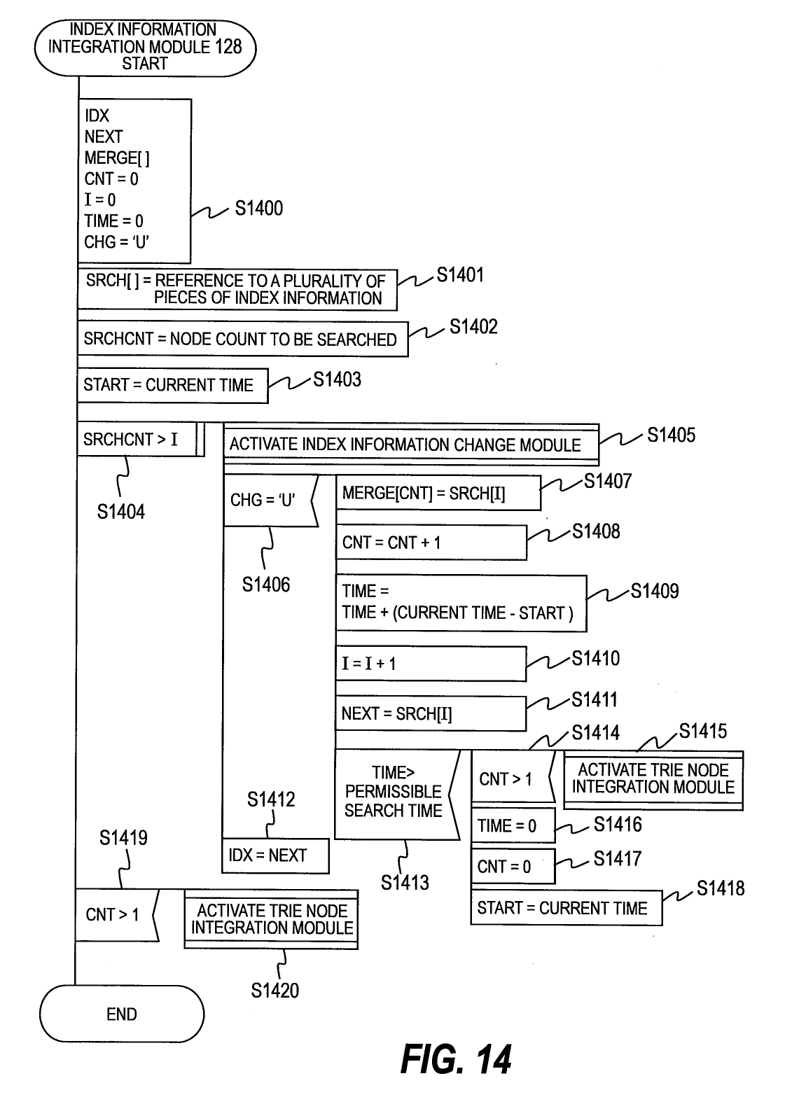

FIG. 14 is a PAD showing the steps of the processing executed by the index information integration module 128 according to the second embodiment of this invention.

The CPU 103 activates the index information integration module 128, and then registers 0 in a variable I indicating a number of the node that is being searched, in a variable TIME for measuring an elapsed time, and in a variable CNT for storing a count of nodes to be integrated. Further, ‘U’ (search completed) is registered in the variable CHG for judging whether or not the integration of the index information is possible (S1400).

The CPU 103 stores in the work area 121 a plurality of pieces of the index information indicated by the pointer information associated with the node retrieved by the trie search module 117, and registers the address of the storage destination in an array variable SRCH (S1401). Also, an array count is registered in a variable SRCHCNT (S1402).

Specifically, in the index 1002 shown in FIG. 10, the pointers indicating the index information associated with the node “A”, the merge node “B-M”, the merge node “N-Y”, and the node “Z”, which are coupled with the node “B” at the uni-gram level in the trie 1000, are registered in the array variable SRCH. In other words, the ptr 2, the ptr 3, the ptr 4, and the ptr 5 are stored in the array variable SRCH. Also, the array count SRCHCNT is 4.

The CPU 103 registers the search start time in a variable START (S1403).

Subsequently, the CPU 103 repeatedly executes the search processing for the index information until there is no node to be searched (S1404).

First, the CPU 103 executes the index information change module 119 to search and update the index information. As a result of the execution of the index information change module 119, the CPU 103 registers ‘N’ in the variable CHG when the search is to be continued, and registers ‘U’ in the variable CHG when the search of the index information blocks managed by the node that is currently searched is completed (S1405). It should be noted that the processing executed by the index information change module 119 is the same as that of the first embodiment of this invention, which has been described with reference to FIG. 7. In the second embodiment of this invention, however, when the flag returned from the index information change module 119 is ‘Y’, which indicates “dividing necessary”, this flag is ignored because the index information that requires dividing does not need to be integrated. In addition, in the case of ‘N’, which indicates “dividing unnecessary”, the search is continued because the search time of the search target index information has not exceeded the permissible search time, leaving the possibility of this index information becoming the integration target. Further, ‘U’ indicates that the search for all the search target index information is completed.

When the value of the variable CHG is ‘N’, the CPU 103 executes the search of the next index information (S1412). When the value of the variable CHG is ‘U’ (S1406), the CPU 103 registers the address of the index information block that has been searched in the CNTth of an array variable MERGE, which is for storing the address of an index information block that may possibly become the integration target (S1407), and increments the value of the variable CNT by 1 (S1408). Further, the CPU 103 measures a time elapsed in the search to set the measured time as the variable TIME. Further, the CPU 103 increments the value of the variable I by 1 in order to shift to the next search target (S1410), and sets the address of the index information block stored in the Ith of the array variable SRCH as the variable NEXT (S1411).

At this stage, in the case where the permissible search time has elapsed (S1413), the CPU 103 judges whether or not the value of the variable CNT is larger than 1. When the value of the variable CNT is larger than 1 (S1414), which means that there are nodes and index information blocks that need to be integrated, the CPU 103 integrates the nodes and the index information blocks by executing the trie node integration module 129 (S1415). Subsequently, regardless of whether or not there has been any integration, the CPU 103 sets the values of the variable TIME and the variable CNT to 0 (S1416 and S1417), and designates a current time as the variable START (S1418).

Lastly, when the search for all the index information is completed, the CPU 103 judges whether or not the value of the variable CNT is larger than 1 (S1419). When the value of the variable CNT is larger than 1, which means that there are nodes available for integration, the CPU 103 executes the trie node integration module 129, thereby integrating the nodes and the index information blocks (S1420).

(Trie Node Integration Module)

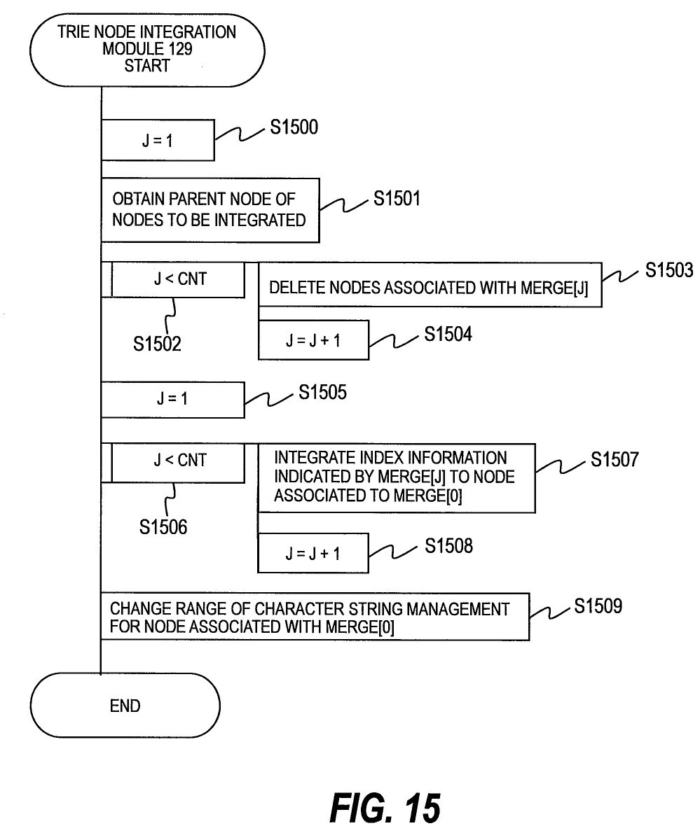

FIG. 15 is a PAD showing the steps of the processing executed by the trie node integration module 129 according to the second embodiment of this invention.

The CPU 103 sets 1 as a variable J, which is a condition variable (S1500). The CPU 103 then obtains the parent node of the nodes to be integrated (S1501), and deletes the nodes associated with the values from MERGE_{[1]} to MERGE_{[CNT-1]} (S1502, S1503, and S1504).

The CPU 103 sets 1 as the condition variable J again (S1505), and links the index information associated with the values from the 0th to the (CNT−1)th of the array variable MERGE, thereby registering the linked index information in the node associated with the MERGE_{[0]} (S1506, S1507, and S1508).

Lastly, when the integration of the index information is completed, the CPU 103 updates the range of the character string management associated with this node to the range of the character string for managing the integrated index information (S1509).

According to the second embodiment of this invention, it is possible to prevent the amount of memory consumption from increasing due to the sparse index information blocks, thereby improving the memory use efficiency.

In addition, the index information integration processing according to the second embodiment of this invention is executed at a time when the update processing or the search processing of the index information is executed. Accordingly, the user can integrate the sparse index information without paying particular attention while executing other normal operations. It should be noted that the index information integration processing may be executed at the user's instruction so that the user can perform the maintenance on the index information in the document registration/retrieval system 100, or may be executed on a regular basis. Moreover, by executing on a regular basis both the index information dividing processing according to the first embodiment of this invention and the index information integration processing according to the second embodiment of this invention, even though addition and deletion of the index information are repeatedly executed, it is possible to maintain a state in which the search of the index information can be started within the permissible search time and also to maintain high memory use efficiency for the trie.

### Another Embodiment

In the first and second embodiments described above, a case where hiragana is used for the nodes and the index information has been described, but katakana or kanji can be used as well. In a case where the text 106 contains a language other than the Japanese language, the characters of the language in question may be used for the nodes and the index information. Further, symbol strings that are symbols associated with one another are also applicable. Here, the symbols constitute symbol codes of 2 bits or 4 bits obtained by dividing character codes formed of 1-byte characters or 2-byte characters.

Further, the respective permissible search times in the first embodiment and second embodiment described above may be identical between the index information dividing and the index information integration, or may be different from each other.

While the present invention has been described in detail and pictorially in the accompanying drawings, the present invention is not limited to such detail but covers various obvious modifications and equivalent arrangements, which fall within the purview of the appended claims.

What is claimed is:

1. A method of creating an index, which is executed in a document retrieval apparatus for retrieving a document,
the index including index information and a trie, the index information including an index item formed of a character string extracted by dividing the document by a predetermined number of the character, the trie being formed of a plurality of nodes each including a part of the character string of the index item,
the document retrieval apparatus having a processor and a storage unit,
the trie being created in the storage unit,
the index information being managed for each index information block constituted of a plurality of pieces of the index information whose index items are identical,
the index information and each of the plurality of nodes of the trie being associated with each other by associating at least one index information block with the each of the plurality of nodes of the trie,
the method executed by the processor comprising the steps of:
dividing the index information by a unit of an index information block when a first node of the trie is associated with a plurality of the index information blocks, and a search time required for searching all the index information associated with the first node of the trie exceeds a predetermined first threshold;
creating a new second node that is to be connected directly below a parent node of the first node of the trie that is associated with the plurality of the index information blocks containing the index information to be searched; and
associating the divided index information with the second node.

2. The method according to claim 1, further comprising the steps of:
searching the index information associated with a third node of the trie until a second predetermined threshold is exceeded when the search time required for searching all the index information associated with the first node of the trie is yet to exceed the predetermined second threshold;
integrating the index information associated with the at least one third node of the trie for which the searching is completed and the index information associated with the first node of the trie when the searching is completed for at least one third node before the predetermined second threshold is exceeded; and
deleting the at least one third node of the trie for which the searching is completed from the trie.

3. The method according to claim 1, wherein the step of dividing the index information is executed for the index information of a search target when the index information is searched for retrieving the document.

4. The method according to claim 1, wherein the step of dividing the index information is executed for all the index information associated with all nodes of the trie when a request for reconstructing the index is received.

5. A method of creating an index, which is executed in a document retrieval device for retrieving a document,
the index including index information and a trie, the index information including an index item formed of a character string extracted by dividing the document by a predetermined number of the character, the trie being formed of a plurality of nodes each including a part of the character string of the index item,
the document retrieval apparatus having a processor and a storage unit,
the trie being created in the storage unit,
the index information being managed for each index information block constituted of a plurality of pieces of the index information whose index items are identical,
the index information and each of the plurality of nodes of the trie being associated with each other by associating at least one index information block with the each of the plurality of nodes of the trie,
the method executed by the processor comprising the steps of:
searching the index information associated with a second node of the trie until a predetermined first threshold is exceeded when a search time required for searching all the index information associated with a first node of the trie is yet to exceed the predetermined first threshold;
integrating the index information associated with the at least one second node of the trie for which the searching is completed and the index information associated with the first node of the trie when the searching is completed for at least one second node before the search time exceeds the predetermined first threshold; and
deleting the at least one second node of the trie for which the searching is completed from the trie.

6. The method according to claim 5, further comprising the steps of:
dividing the index information by a unit of an index information block when the first node of the trie is associated with a plurality of the index information blocks, and the search time required for searching all the index information associated with the first node of the trie exceeds a predetermined second threshold;
creating a new third node that is to be connected directly below a parent node of the first node of the trie that is associated with the plurality of the index information blocks containing the index information to be searched; and
associating the divided index information with the third node.

7. The method according to claim 5, wherein the step of integrating the index information is executed for the index information of a search target when the index information is searched for retrieving the document.

8. The method according to claim 5, wherein the step of integrating the index information is executed for all the index information associated with all nodes of the trie when a request for reconstructing the index is received.

9. A document retrieval apparatus for retrieving a document with use of an index, comprising a processor and a storage unit, wherein:
the index includes index information and a trie, the index information including an index item formed of a character string extracted by dividing the document by a predetermined number of the character, the trie being formed of a plurality of nodes each containing a part of the character string of the index item;
the trie is created in the storage unit;
the index information is managed for each index information block constituted of a plurality of pieces of the index information whose index items are identical;
the index information and each of the plurality of nodes of the trie are associated with each other by associating at least one index information block with the each of the plurality of nodes of the trie; and
the processor is configured to:
dividing the index information by a unit of an index information block when a first node of the trie is associated with a plurality of the index information blocks, and a search time required for searching all the index information associated with the first node of the trie exceeds a predetermined threshold;
create a new second node that is to be connected directly below a parent node of the first node of the trie that is associated with the plurality of the index information blocks containing the index information to be searched; and
associate the divided index information with the second node.

10. A machine-readable medium containing at least one sequence of instructions for controlling a document retrieval apparatus to execute a processing of creating an index,
the index including index information and a trie, the index information including an index item formed of a character string extracted by dividing the document by a predetermined number of the character, the trie being formed of a plurality of nodes each containing a part of the character string of the index item,
the sequence of instructions causes the document retrieval apparatus to:
create the trie;
manage a plurality of pieces of the index information whose index items are identical as an index information block;
associate the index information with each of the plurality of nodes of the trie by associating at least one index information block with the each of the plurality of nodes of the trie;
dividing the index information by a unit of an index information block when a first node of the trie is associated with a plurality of the index information blocks, and a search time required for searching all the index information associated with the first node of the trie exceeds a predetermined threshold;
create a new second node that is to be connected directly below a parent node of the first node of the trie that is associated with the plurality of the index information blocks containing the index information to be searched; and
associate the divided index information with the second node.
